(19) United States
(12) Patent Application Publication
(10) Pub. No.: US 2023/0254213 A1
(43) Pub. Date: Aug. 10, 2023

(54) SYSTEMS AND METHODS FOR PROTECTING COMPUTING SYSTEMS USING DECLARED CONSTRAINTS

(71) Applicant: Level 3 Communications, LLC, Broomfield, CO (US)

(72) Inventors: William Power, Boulder, CO (US); Praveen Mohandas, Thousand Oaks, CA (US); Laurence Lipstone, Calabasas, CA (US); Paul Carpenter, Tulsa, OK (US)

(73) Assignee: Level 3 Communications, LLC, Broomfield, CO (US)

(21) Appl. No.: 18/106,232

(22) Filed: Feb. 6, 2023

Related U.S. Application Data
(60) Provisional application No. 63/267,644, filed on Feb. 7, 2022.

(51) Int. Cl. H04L 41/0894; H04L 41/0896; H04L 41/08

(52) U.S. Cl. CPC H04L 41/0894; H04L 41/0896; H04L 41/0886

(57) ABSTRACT

Systems and methods for managing configuration changes to a network are provided. In examples, the configuration rules are received and stored in a staging directory. If the configuration rules are validated, the rules are moved to a running directory. Thereafter a request to make a change to a configuration parameter is received. The request may comprise a configuration change object, and the configuration change object may be stored in the staging directory. The configuration change object may be evaluated against the rule (and other rules of the network), and it may be moved to the running directory only after satisfying all applicable rules. In some examples, applying the rule(s) may include determining whether the configuration change exceeds a network limit on changes of a particular type with a preset time period.

### CROSS-REFERENCE TO RELATED APPLICATIONS

This application claims the benefit of U.S. Provisional Application No. 63/267,644 filed Feb. 7, 2022, entitled “Systems and Methods for Protecting Computing Systems Using Declared Constraints,” which is incorporated herein by reference in its entirety.

### FIELD

One or more aspects of embodiments according to the present disclosure relate to telecommunications networks, and more particularly to protecting entities in the telecommunications network via declared constraints.

### BACKGROUND

The Internet and other networks are easily accessible using numerous possible devices. Content providers may use computer networks, like the Internet, to provide all kinds of content to devices throughout the world. In order to offload the job of serving some or all of its content, many content providers may operate or subscribe to content delivery networks (CDNs), which are, generally speaking, networks optimized to storing and delivering content. Using a CDN, content may be served to clients from the CDN (e.g., from one or more content servers in the CDN) instead of from the content provider's server(s).

There are times when updates or maintenance may need to be made to components of the CDN. The updates may be pushed to the components by a human operator, and/or generated automatically via software. Because humans and software are both prone to errors, it is possible that the updates pushed to the components of the CDN may cause the CDN to malfunction, and even cause a global shutdown of the CDN. It is desirable, therefore, to protect the CDN from malfunction due to updates pushed to the CDN.

The above information disclosed in this Background section is only for enhancement of understanding of the background of the present disclosure, and therefore, it may contain information that does not form prior art.

### SUMMARY

An embodiment of the present disclosure is directed to a method comprising: receiving a request configured to make a change to a component of a telecommunications network; applying a rule to the request and generating an output; rejecting the request in response to the output indicating a first result; and processing the request in response to the output indicating a second result.

According to one embodiment, the method further includes storing the request in a staging directory; and moving the request from the staging directory to a running directory in response to the output indicating the second result.

According to one embodiment, the request is a request to change a configuration parameter of a device coupled to the telecommunications network.

As a person of skill in the art should recognize, embodiments of the present disclosure provide protection of a telecommunications network (e.g., CDN or edge compute cluster) from malfunction or shutdown due to updates pushed to the CDN, that may be more effective than trying to fix software coding errors at the source, and/or trying to train operators to make no mistakes. Because there are no guarantees that a human operator will not make mistakes and/or software code will not have bugs, the claimed systems and methods that use such constraints/rules may be generally more effective in providing protection to the telecommunications network.

These and other features, aspects and advantages of the embodiments of the present disclosure will be more fully understood when considered with respect to the following detailed description, appended claims, and accompanying drawings. Of course, the actual scope of the invention is defined by the appended claims.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 is a block diagram of a telecommunications network according to one embodiment;

FIG. 2 is block diagram of a process for making a change to a name server according to one embodiment;

FIG. 3 is a messaging diagram of different types of messages that may be exchanged between a defender user interface, defender server, and defender client according to one embodiment;

FIGS. 4A-4B are flow diagrams of a process for validating and applying rules according to one embodiment; and

FIG. 5 is a block diagram of a computing device according to one embodiment.

### DETAILED DESCRIPTION

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, in the drawings, the relative sizes of elements, layers, and regions may be exaggerated and/or simplified for clarity.

A content provider may provide content to a requesting device via a content delivery network (CDN). Both the content provider and the requesting device may have a general expectation that the CDN will be operational at all times to deliver the requested content. Unfortunately, however, changes to one or more components of the CDN may cause the CDN to fail. For example, corrupt configuration and/or software updates pushed to the CDN may cause the CDN to malfunction.

In general terms, embodiments of the present disclosure are directed to systems and methods for protecting a telecommunications network such as, for example, a CDN or an edge compute network/cluster, from malfunction, via declared constraints/rules. In one embodiment, instead of identifying and fixing individual sources of corrupt data/commands/codes (collectively referenced as corrupt data), a defender system intercepts a change request directed to a CDN component, applies the declared constraints/rules (collectively referenced as rules) to the change request, and releases the change request for consumption in response to the change request satisfying the declared rules. A change request that does not meet the declared rules is rejected, and a notification may be sent to a device operator for taking appropriate action.

Although the various embodiments are described in terms of CDN, it should be appreciated that aspects of the present disclosure may apply to any type of telecommunications network that utilizes IP addresses for connecting a device to one or more components of the network to retrieve content. For example, aspects of the disclosure may be utilized in a network that connects a device to an endpoint in the network, a conferencing server, a virtual private network device, and the like.

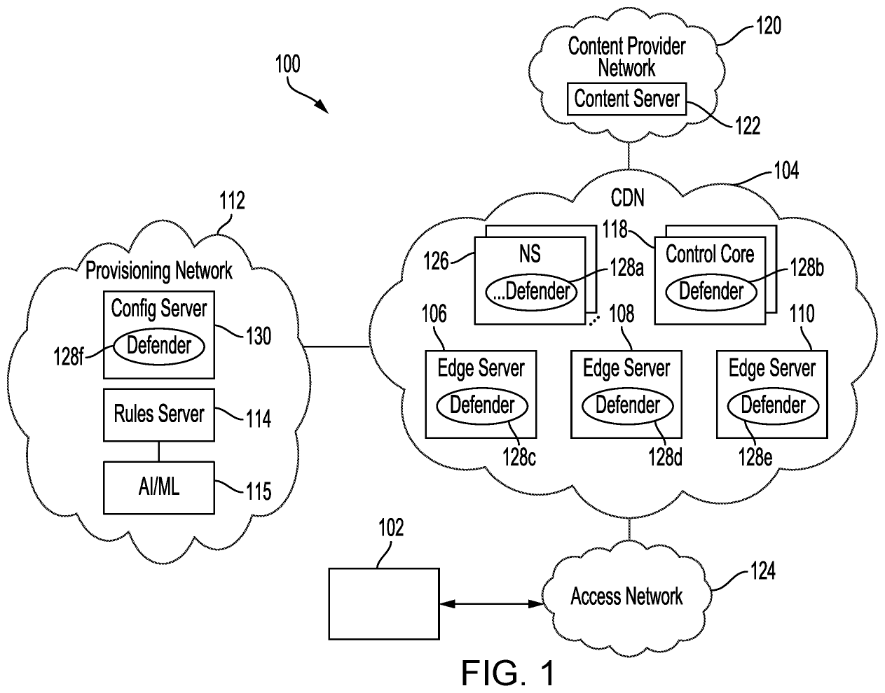

FIG. 1 is a block diagram of a telecommunications network 100 according to one embodiment. The telecommunications network 100 includes, without limitation, a content provider network 120, content delivery network (CDN) 104, access network 124, and provisioning network 112.

The content provider network 120 may include a content server 122, which may be an original source of content to be delivered to a requesting device 102. Although the content server 122 is depicted as being in a separate content provider network 120, the content server may, in some embodiments, be embodied in the CDN 104 itself.

In general, the CDN 104 comprises one or more servers/components configured to work together to provide content to a device upon request, and an underlying IP network through which the request is received and the content is provided. The underlying IP network associated with the CDN servers may be any type of IP-based communication network configured to transmit and receive communications through the network, and may include any number and types of telecommunications components. In this manner, CDN-based components may be added to an existing IP-based communication network such that the components receive a request for content, retrieve the content from a storage device, and provide the content to the requesting device through the supporting IP network.

The CDN 104 may include a plurality of servers such as, for example, one or more edge servers 106-110, name servers 126, and control cores 118. In one embodiment, the edge servers 106-110 are configured to locally store content provided by the content server 122, in a cache. In this manner, the content may be made more geographically or logically proximate to the location of a requesting device (e.g., device 102), helping reduce network loads, optimize utilization of available capacity, lower delivery costs, and/or reduce content download time. In some embodiments, the edge servers 106-110 may be configured to provide requested content to the requesting device via other devices in, for example, the access network 124.

The name server(s) 126 may be configured to process a request for content by providing a network address (e.g., an IP address) where the requested content can be obtained. In one implementation, the name server 126 provides a domain name system (DNS) service which resolves an alphanumeric domain name to an IP address. For example, to request content from the CDN 102, a requesting device or network may provide a URL associated with the content. The name server 126 may resolve the link name (e.g., URL, host name, or other identifier) to an associated network address within the CDN 104 from which the device 102 can retrieve the content.

The requesting device 102 may contact one of the edge servers 106-110 at the provided network address to request the content. The request may include information including a URL, which may include an identification of the requested content. In some instances, the access network 124 may also include a DNS service. Devices within the CDN 104 may also have a URL or other name associated with the device for use in routing communications, such as requests for content, to any other device within the network 104, connected to the network, or in communication with the network.

In one embodiment, the device 102 (sometimes referred to as a requesting device) connects to the CDN 104 through the access network 124 to request and receive content or content files from the CDN. The access network 124 may be under the control of, or operated/maintained by, one or more entities, such as, for example, one or more Internet Service Providers (ISPs) that provide access to the CDN 104. Thus, for example, the access network 124 may provide Internet access to the device 102. Other users may also connect to the CDN 104 through access network 124. In general, access to a CDN 104 (or underlying IP network associated with the CDN) may occur through any number of ingress ports to the CDN through any number of access networks.

The device 102 transmitting requests for content may be generally any form of computing device, such as a personal computer, mobile device, tablet, set-top box, smart TV, or the like, configured to request, receive, process, and/or present content. In one example, the device 102 includes an Internet browser application with which a link (e.g., a hyperlink) to a content item may be selected or otherwise entered, causing a request to be sent to one of the edge servers 106-110 from which the content may be available to serve to the device.

In one embodiment, the telecommunications network further includes a provisioning network 112 coupled to the CDN 104. The provisioning network 112 may be configured to provide software, configuration files, rules, and/or the like, to one or more components of the CDN 104. Although the provisioning network is depicted as a separate network, in some embodiments, components of the provisioning network are included in the CDN itself.

In one embodiment, the provisioning network 112 includes a configuration server 130, a rules server 114, and an artificial intelligence (AI)/machine learning (ML) engine 115. The configuration server 130 may be accessible to an operator to create and push different types of configuration data that the CDN may need to carry out its intended functions. For example, the configuration data may be transmitted when the CDN is deployed, and periodically afterwards to provide updates as the various networks 104, 120, 124 evolve. The configuration data may include, for example, different tables used by the name server 126 such as, for example, a table storing server load information (referred to below in Table 1 as a VLT), a table for storing server virtual IP addresses (VIPs) (referred to below in Table 1 as a VBT), and/or a table for storing server distance information (referred to below in Table 1 as a VDT).

Rules may be one type of configuration data that may be created, updated, and pushed to one or more components of the CDN. In one embodiment, the rules server 114 is accessible to a system operator to declare rules for use by different components of the CDN. Different rules may be declared for the different components to protect them against corrupt data that may cause malfunction of the CDN. For example, a particular rule may be declared to reject a table that is pushed to the name server 126 if the table fails to satisfy the parameters set forth by the rule. Nonexclusive, nonlimiting exemplary rules that may be declared for a name server 126 are included below in Table 1.

TABLE 1

| Rule Domain/ | | |
|---|---|---|
| Category | Rule # | Rule Description |
| Table Size | 1.1 | Reject BDT, VLT, VDT updates if the |
| | | number of VIPs is <X |
| | 1.2 | Reject BindingTable updates if the |
| | | number of Subscriber Bindings is <X |
| | 1.3 | Reject BDT, VLT, VDT updates if the number |
| | | of available ‘non loadshare 0’ VIPs is <X |
| | 1.4 | Reject BDT, VLT, VDT updates if the number |
| | | of available ‘non shedding’ VIPs is <X |
| Corrupt | 1.4 | Reject BDT, VLT, VDT updates if the md5 of |
| Content | | the tables do not match the original source |
| Data Age | | Reject BDT, VLT, VDT updates if the file |
| | | is older than X hour old |
| Network | 2.1 | Reject VDT updates if Resolver to VIP |
| Distance | | distances indicate that <X VIPs are accessible |
| GEO Data | 3.1 | Reject GEO data update if it has reduced |
| | | by more than X % |
| | | Reject GEO data update if the IPv4 or IPv6 |
| | | GEO mappings contain more than Y % change |
| Master | 4.1 | Reject Master Table updates if they have |
| Configs. | | shrunk by more than X % |

As shown in Table 1, each rule may be associated with a domain/category. In examples, the domain/category of a rule may also be referred to as a rule type. Each domain may set forth the rule variables applicable to the domain/category, and rule expressions that define the rules. For example, a variable in the “table size” domain/category may be a virtual Internet protocol (VIP) count to check whether the number VIPs in a table update is less than a preset number. Updating than a threshold number of VIPs, for example, may be a greater risk to the network.

The rules server 114 may be configured to restrict access to the rules to users that have administrative privileges. In addition, the rules server 114 may be configured to maintain a history of changes to the rules.

In one embodiment, the AI/ML engine 115 may be configured with one or more machine learning models that have been trained using supervised and/or unsupervised learning algorithms for adjusting/tuning the rules based on network data. For example, network metrics/data such as a client's DNS resolver IP address may be provided as input to the AI/ML engine 115, and the engine may be configured to recommend optimal values for the variables associated with the rules, such as the best CDN cache that is predicted based on the DNS resolver IP address. The rules may be adjusted (e.g., automatically) based on the recommended optimal values.

For ease of understanding, the various embodiments are described in terms of rules that are implemented by the name server(s) 126. However, it should be understood that rules may be provided to, and implemented by, any component of the CDN, including, for example, the control core 118, edge servers 106-110, and the like. Rules may also be provided to, and implemented by, the configuration server 130.

In one embodiment, provisioned rules provided by the rules server 114 are received by the control core 118 for distribution to the intended components of the CDN. The name server(s) 126 and other intended recipients may retrieve the provisioned rules from the control core 118. In examples, any new rules that are provided, e.g., by the configuration server 130, are, themselves, considered configuration data and subject to the same validation procedures discussed herein. As such, a new rule may be received and validated and then used to validate further configuration changes.

In one embodiment, a defender system 128a-128e (collectively referenced as 128) is included in the name server(s) 126 and the other components of the CDN (e.g., control core 118 and edge servers 106-110) for retrieving and applying the rules to protect these components from corrupt configuration data. A defender system 128f may also be included in the configuration server 130 and/or other components of the provisioning network 112. In examples, the defender system 128 may include multiple hardware and software components that cooperate to protect the telecommunications system 100 from corrupt configuration data.

In examples, the distribution of the defender system 128 on multiple components of the network help protect the network from corrupt configuration data on multiple levels. For example, in one embodiment, the defender system 1287f in the configuration server may check for errors in an input level. As the configuration data is distributed to the control core 118, the defender system 128b in the control core validates the data prior to further distributing the data to other components, such as the name servers 126. The names servers 126 may further engage in their own independent check against their rules for further validating the data at their level prior to applying the configuration change.

In one embodiment, the defender system 128 operates in a client/server mode via a server component (hereinafter defender server) and a client component (defender client). The defender system 128 may have both the server and client components in a single device, or the server and client components may be executed on different devices. For example, the server may be remote from the client component when the client device is small, such as an Internet-of-Things (IOT) device. In another example, the configuration server 130 may include both the client and server components, but only the client component may be included on the application servers (such as the name server and/or edge servers 106-110). In this latter instance the server component may be included in the control core 118, and the client component in the application server may transmit validation requests to the server component in the control core 118.

In examples, the server component of the defender system 128 may be configured to retrieve and validate the provisioned rules from the defender system 128b of the control core 118, from rules server 114, or from another component. Once configured, the defender server may wait for client requests for rules evaluation of input data. The output of the defender server, upon evaluating the input data, may be a success or failure, which may determine the acceptance of the input data. For example, where all applicable rules are satisfied, the output may be success, and the configuration change is accepted. Otherwise, the configuration change may be rejected.

The client component of the defender system 128 may be configured to monitor for input data, extract rule variables, compose evaluation requests, and send the evaluation requests to the defender server. Evaluation requests may be sent using the Hypertext Transfer Protocol (HTTP). Values for the variables may be passed as part of the evaluation request. In one embodiment, the input data may be accepted in response to a success output by the defender server, and rejected in response to a failure output by the defender server.

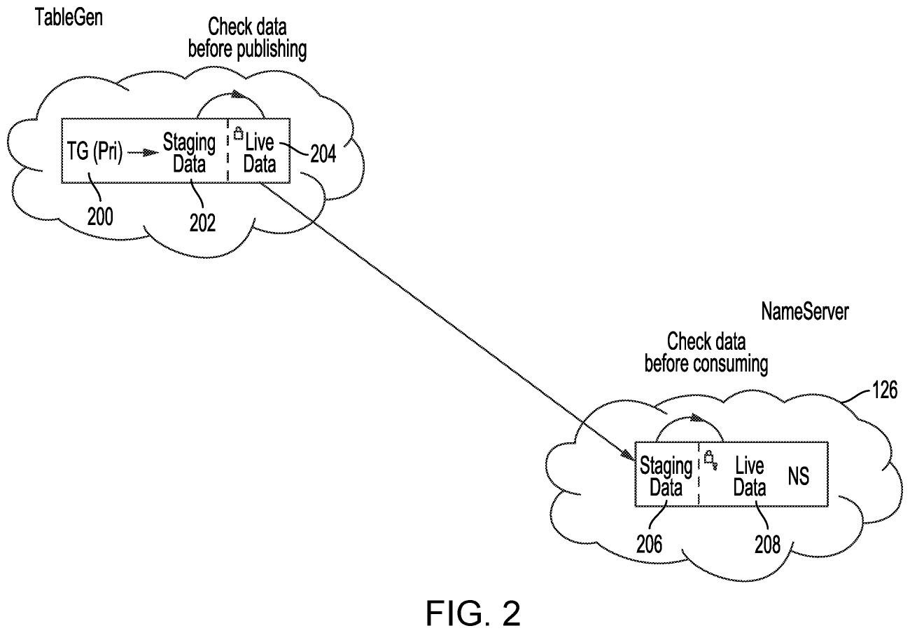

FIG. 2 is block diagram of a process for making a change to the name server according to one embodiment. In one example, an application running in the configuration server 130 may generate and publish configuration data updates to the name server 126. The application may be, for example, a table generation (TableGen) application 200, and the configuration data may be an updated table 202 such as a table storing server load information, a table storing server virtual IP addresses, or a table storing server distance information. In an embodiment where the configuration data is to be published to multiple name servers 126 in the network, the configuration server 130 may select a subset of the servers to publish to first, to allow validation of the rules by the subset of the name servers prior to publishing to the remaining name servers.

In one embodiment, the TableGen application 200 is configured to invoke the installed defender system 128f to check the data against its rules to determine whether the data complies with the rules. In this regard, the data is initially saved in a staging directory 202 (e.g., $configroot/staging-data/TG) which triggers the defender system 128f to evaluate the data against the rules in a domain/category associated with the data. An exemplary rule may be configured to reject table updates that have fewer than X % (or more than Y %) of the provisioned VIP addresses. Another exemplary rule may be configured to reject configuration data with a hash value different from an expected/original hash value (to ensure that configuration data originated at a trusted source).

If the data can be validated against the rules, the defender system 128f moves the data into a running directory 204 (e.g., $configroot/live-data/TG). The configuration server 130 may then publish the live configuration data in the running directory to the name server 126. In one embodiment, configuration data that cannot be validated against the relevant rules is not moved into the running directory 204 and hence, not published to the name server 126.

In one embodiment, a monitoring application at the name server 126 receives the configuration data published by the TableGen application 200, and invokes the defender system 128a to validate the received data. The validation may help protect the name server 126 against any corruption to the data that may have occurred, for example, after validation of the data by the defender system 128f in the configuration server 130 (e.g., during transit to the name server 126). The monitoring application may be configured to store the received data in a staging directory 206 (e.g., $configroot/staging-data/TG). The receipt of the data in the staging directory 206 may invoke the defender system 128a to evaluate the data in the staging directory 206. If the data is validated against the rules, the defender system 128a may notify the monitoring application which may then move the data into a running directory 208 for consumption. In some embodiments, the data is moved from the staging directory 206 to the running directory by the defender system 128a itself.

In one embodiment, the name server 126 is configured to monitor the running directory 208 for configuration data updates, and apply/consume the updates in the running directory 208. Current configuration of the name server 126 changes in response to applying/consuming the data updates. In one embodiment, configuration data that cannot be validated against the relevant rules is not moved into the running directory 208, and a notification may be sent to an operator indicating the validation failure.

In examples, an upper time bound (e.g., 60 seconds) may be imposed on the defender system 128 to validate data in the staging directory 202, 206. This may prevent bad staging data from blocking validation of new staging data. In certain examples, it may be desirable for an operator to dynamically override a rule that blocks validation of configuration data in the staging directory 202, 206, and force validation of the data. For example, configuration data to be pushed to the name server 126 may be a binding table with fewer virtual IP addresses (VIPs) than what the rules would allow. The defender system 128 may block validation of such data as violating one of its rules. However, if there is an unexpected operational condition (e.g., a security attack) that would require the configuration change despite the violation of the rule, the defender system 128 is configured for such operator override. For example, the violation of the rule may be necessary to remove compromised VIPs from the table. In one embodiment, the operator may dynamically change the rule (e.g., by changing threshold values) to allow the configuration data to be validated. In examples, an electronic link to instruct the defender system 128 to override the violation of a rule is included in a notification sent to an operator indicating the validation failure, such that, if a selection of the link is received, the defender system 128 automatically overrides the validation failure and permits the configuration data to be validated.

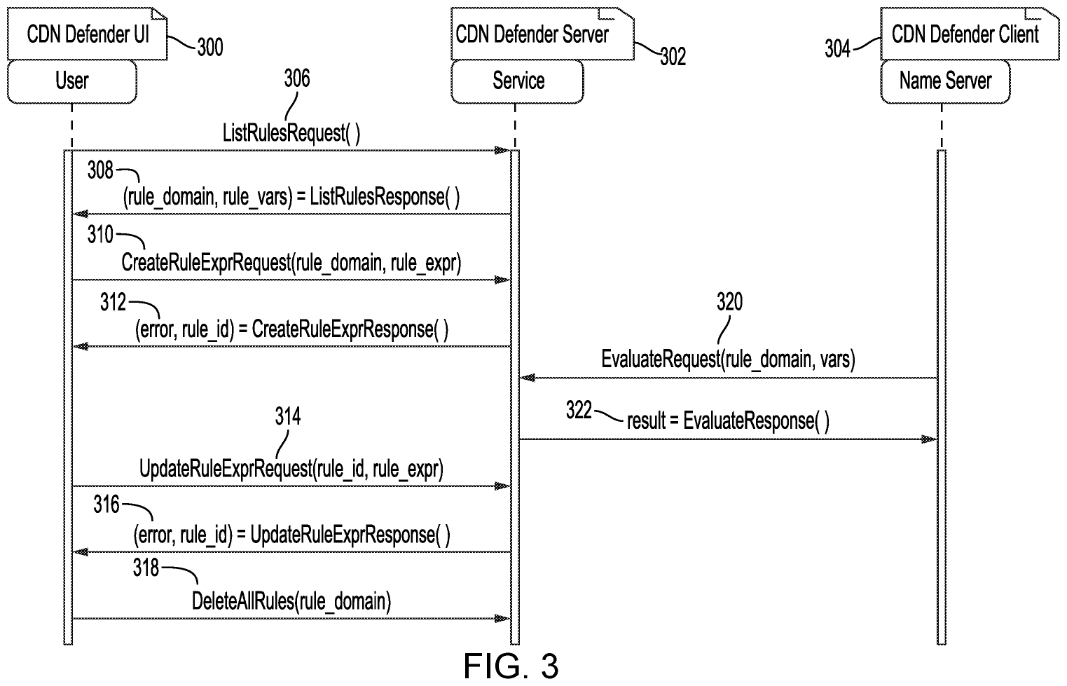

In one embodiment, application of rules by a component of the CDN that has a defender system 128 installed is via communications between the server component of the module and the client component of the module, as discussed in further detail with respect to FIG. 3.

FIG. 3 is a messaging diagram of different types of messages that may be exchanged between a defender user interface 300, defender server 302, and defender client 304, according to one embodiment. In the example of FIG. 3, the defender server and client 302, 304 are services provided by the defender system 128a of the name server 126. In other examples, the control core 118 may operate as the defender server 302, while the name server operates defender system 128a as the defender client 304. Other implementations are possible.

In one embodiment, the defender user interface 300 may make different HTTP requests to the defender server 302 relating to different rules. In this regard, the defender user interface 300 may be part of the configuration server 130. The requests by the defender user interface 300 may include, for example, a list request 306 for obtaining information of current rules. The defender server 302 may provide a list response 308 including, for example, a domain/type of rules in place, and variables associated with the rules, in response to the list request 306.

The defender user interface 300 may also transmit a rule create request 310 to the defender server 302 for creating a rule. In this regard, a system operator may access the user interface 300 to declare one or more rules. For example, the system operator may identify a domain/type of the rule to be created, and the expression associated with the rule. In examples, the user interface 300 may transmit the rule create request 310 directly to the defender server 302 or through a variety of intermediate devices. In some examples, all rule create requests 310 may be received by control core 118 before being propagated to name server 126 or edge servers 106, 108, 110, etc.

As one or more networks 120, 104 evolve, updates may need to be made to the provisioned rules. In this regard, the system operator may also access the defender user interface 300 to make the updates via updated rules declarations. The updates may be transmitted in one or more rule update requests 314, each request comprising a rule change object. Each request 314 may include, for example, the rule ID of the rule to be updated, and the updated rule expression for the update rule. In response to the rule creation or rule update requests 310, 314, the defender server 302 may transmit appropriate responses 312, 316 to the defender user interface 300 indicating whether the rules have been successfully created or updated.

In examples, the defender user interface 300 may also submit a request 318 to delete all rules of a particular domain/type.

In examples, the defender client 304 transmits an evaluation request 320 in response to configuration data updates being placed in the staging directory 206. In examples, the defender client 304 extracts relevant variables from the received configuration data, and includes the extracted variables in the request along with identification of a rule domain. The evaluation request 320 may comprise a configuration change object including the configuration data, the extracted variables, and/or the identification of the rule domain. The rule domain may be identified, for example, based on the configuration data received by the name server running defender client 304.

The defender server 302 may receive the evaluation request 320 and apply the configured rules to the request. If the request complies with all the rules, the request is validated, and an appropriate response 322 is transmitted to the defender client 304. If the response 322 indicates a success, the configuration data in the staging directory 206 is moved (e.g., by the defender client 304) to the running directory 208. If the response indicates a failure, a “failed” indicator may be appended to the configuration data (e.g., configuration file), and left in the staging directory 206. An alert may then be transmitted to an operator of the configuration server 130.

In order for the defender server 302 to provide evaluation services, rules are distributed to the server 302 via, for example, the control core 118 or another element of the network. The rules may differ depending on the type and/or software version of the server receiving the rules. In one embodiment, the rules used by the defender server 302 may, themselves, be deemed to be configuration data. Thus, in one embodiment, the rules are processed as other types of configuration data by placing the rules in the staging directory 206, and moving the rules to the running directory 208 only after the rules have been validated.

Upon initialization of the defender server 302, the server examines the staging directory 206 for a rules file (e.g., a file that ends in rules_config.json) that needs validating. If the staging directory is empty, the running directory 208 may be checked for validated rules.

In validating the rules in the staging directory 206, the defender server 302 may check the signature (e.g., hash value) of the rules file to ensure that the rules file did not change in transit from the rules server 114 to the name server 126. In this regard, the defender server 302 may determine whether the signature matches an original signature created by the rules server 114 when the original rule file was created. The original signature may be made available to the defender server 302 via, for example, the control core 118. The rules file may be moved to the running directory 208 if the rules file is validated.

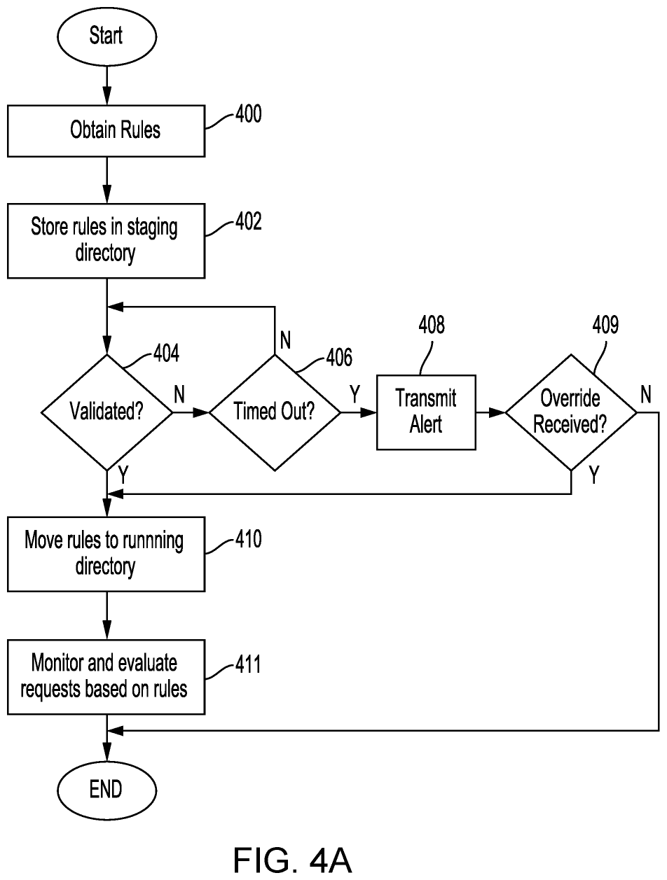

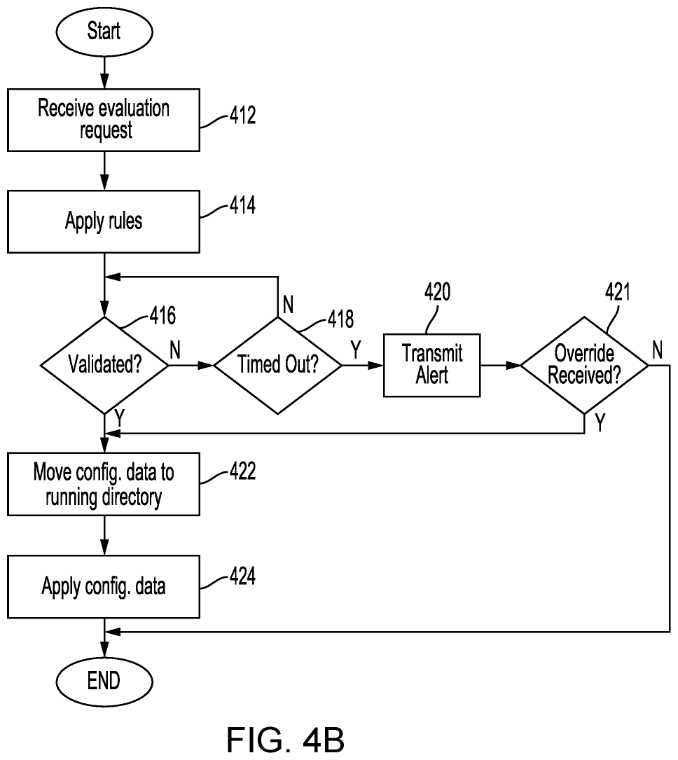

FIGS. 4A-4B are flow diagrams of a process for validating and applying rules according to one embodiment. It should be understood that the sequence of steps of the process is not fixed, but can be modified, changed in order, performed in any order (e.g., sequentially, concurrently, or simultaneously), or altered into any desired sequence as recognized by a person of skill in the art. Also, although the process is described as being implemented by the defender system 128a in the name server 126, the same process may apply for any defender system 128b-128f installed in any component of the telecommunications system 100. In examples, the elements of FIGS. 4A and 4B may also be implemented collectively by more than one of the defender systems 128a-128f. In addition, a rule may be validated in multiple elements (e.g., name server 126, control core 118, configuration server 130, edge servers 106, 108, 110, etc., before being applied to ensure that the rule is still valid, has not been altered since having been validated, and still meets all conditions (including network conditions) necessary for the rule to be applied.

The process starts, and at operation 400, the defender server 302 obtains the provisioned rules from the control core 118. In examples, the rules are retrieved by actively pulling the rules in a request from the defender server 302 or pushing the rules from the control core 118 to defender server 302. In examples, the rule(s) may be provided to the defender server 302 in rules objects or rule change objects. The retrieved rules are stored in the staging directory 206 at operation 402. In one embodiment, the defender server 302 validates the rules in the staging directory 206 against a set of validation criteria. The validation criteria may comprise, for example, whether the signature associated with the rules matches a stored signature, whether the retrieved rules would cause a total number of rule changes that exceeds a set network threshold, whether any of the retrieved rules would cause dependency issues with other existing rule objects, or any other validation criteria, as discussed further in this application.

At operation 404, the defender server 302 determines whether the rules have been validated. If the answer is NO, the defender server 302 may continue to attempt validation for a preset time period (e.g., 60 seconds). In some examples, the defender server 302 may also receive a response indicating that the rules have been rejected.

At operation 406 a determination is made as to whether the validation period has expired (or a rejection of the rules has been received). If the answer is YES, an alert is transmitted at operation 408. The alert may be received, for example, by an operator of the rules server 114. The operator may take appropriate action in response to the alert. For example, the operator may correct the configuration object (e.g. when the rule is correct but the configuration object is incorrect), or correct the rule (e.g. when the configuration object is correct but the rule is too restrictive). In some examples, the action may be an override action to force validation of the rule. Accordingly, at operation 409, a determination is made as to whether an override action is detected. If the answer is YES, the rules are validated.

Referring again to operation 404, if the rules are validated (or if an override action has been received), the rules are moved to the running directory 208 at operation 410. In this regard, a notification may be sent to the monitoring application that the rules have been validated, prompting the monitoring application to move the rules to the running directory 208. The rules may now be ready to be applied against validation requests from a client. In this regard, at operation 411, the defender server 302 monitors and evaluates requests from the defender client 304.

A more detailed flow diagram of the process for validating configuration data (also referred to as configuration objects) based on rules is provided in FIG. 4B. At operation 412, the defender server 302 receives an evaluation request from the defender client 304. In one embodiment, unvalidated configuration data pushed to the name server is initially placed in the staging directory 206. The defender client 304 may be configured to monitor the staging directory 206 for new data. In response to receipt of such data, the defender client 304 may be configured to extract the variables from the data and generate the evaluation request. The evaluation request may include a configuration change object including the extracted variables and an identification of the applicable rule domain. For example, if the configuration data includes changes to a load feedback table, a “table size” domain may be identified as the applicable rule domain for the request. The variable to be extracted and included in the evaluation request may be, for example, a number of VIPs in the table.

At operation 414, the defender server 302 applies the rules in the applicable rule domain to the extracted variables. The rules may check whether the extracted variables satisfy the minimum or maximum constraints set by the rules. For example, one of the rules may determine whether the extracted number of VIPs is below or above a required minimum number. If the extracted number of VIPs is above the minimum number (and/or below a maximum number), the configuration data updates may be validated and allowed. Another rule may check whether a change from a current configuration state to the new configuration state proposed by the configuration data updates satisfies a maximum change level. For example, a proposed configuration change where more than 50% of the configurations of a particular type of device are changed may be disallowed.

In some embodiments, the rules may have different levels of complexity in checking the configuration data. For example, a first level check of the rules may be a syntax check that determines whether the proposed configuration data updates have an appropriate syntax. A second level check of the rules may be more sophisticated, and determine, for instance, whether in aggregate, a collection of configuration objects satisfy a particular rule. For example, a particular rule may require that an aggregate of the configuration changes of a particular type do not exceed a rate of change that is above a maximum (e.g., not more than 10% in any one day). Another rule may check whether the configuration object has a dependency with another configuration object (or whether any other configuration object is dependent on it), and whether the change will break the other configuration object. Yet another rule may check whether references in the configuration object (e.g., SSL certificates) to other objects are correct.

At operation 416, the defender server 302 determines whether the configuration data may be validated. The configuration data may be validated in response to the data satisfying all the rules in the rule domain. A response indicating the validation may be transmitted to the defender client 304.

In response to the configuration data being validated, the data is moved to the running directory 208 at operation 422. In this regard, a notification may be sent to the monitoring application that the configuration data has been validated, prompting the monitoring application to move the data to the running directory 208. The data may also be moved by the defender client 304.

At operation 414, the configuration data is applied, and the current configuration state of the name server is modified to an updated configuration state.

Referring again to operation 416, if the configuration data cannot be validated, the defender server 302 may continue to attempt validation for a preset time period (e.g., seconds), or until a rejection is received.

At operation 418, a determination is made as to whether the validation period has expired (or a rejection was received). If the answer is YES, an alert is transmitted at operation 420. The alert may be received, for example, by an operator of the configuration server 112. In certain situations (e.g., to deal with an unforeseen condition for the network including security attacks), the operator may take an override action to force validation of the rule in response to the alert. For example, the operator may dynamically change an aspect of the rule blocking the validation, such as, for example, a minimum or maximum threshold specified in the rule. In this regard, a determination is made at operation 421 as to whether an override action has been received. If the answer is YES, the rules are validated.

In some embodiments, rules may also be employed in situations other than validating configuration change requests. For example, a component of the CDN may monitor and extract metrics (e.g., the number of VIPs) in real time, to determine whether the network is approaching limits set by the rules. Alarms may be triggered when the extracted metrics are within a certain threshold (e.g., within 5% of the set limits). In response to the alarms, a system operator may determine whether the limits set by the rules should be adjusted.

In some embodiments, the various servers and modules discussed above, are implemented in one or more processors. The term processor may refer to one or more processors and/or one or more processing cores. The one or more processors may be hosted in a single device or distributed over multiple devices (e.g., over a cloud system). A processor may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processor, as used herein, each function is performed either by hardware configured, i.e., hard-wired, to perform that function, or by more general-purpose hardware, such as a CPU, configured to execute instructions stored in a non-transitory storage medium (e.g., memory). A processor may be fabricated on a single printed circuit board (PCB) or distributed over several interconnected PCBs. A processor may contain other processing circuits; for example, a processing circuit may include two processing circuits, an FPGA and a CPU, interconnected on a PCB.

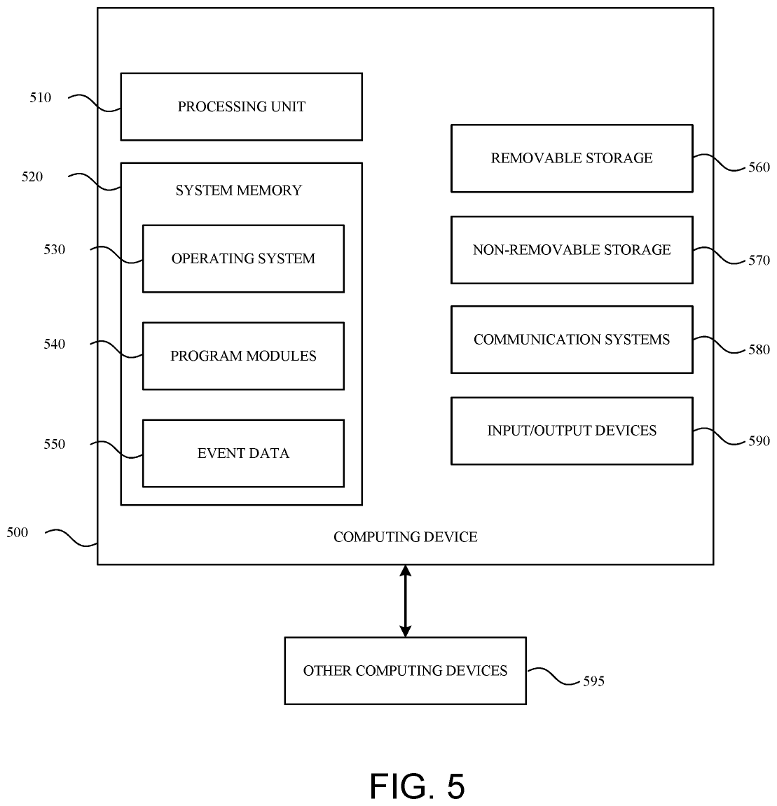

FIG. 5 is a block diagram of a computing device 500 according to an example. The computing device 500, or various components and systems of the computing device 500, may be integrated or associated with configuration server 130, rules server 114, AI/ML engine 115, edge servers 106, name server 126, control core 118, content server 122, client device 102, etc. As shown in FIG. 5, the physical components (e.g., hardware) of the computing device are illustrated and these physical components may be used to practice the various aspects of the present disclosure.

The computing device 500 may include at least one processing unit 510 and a system memory 520. The system memory 520 may include, but is not limited to, volatile storage (e.g., random access memory), non-volatile storage (e.g., read-only memory), flash memory, or any combination of such memories. The system memory 520 may also include an operating system 530 that controls the operation of the computing device 500 and one or more program modules 540. The program modules 540 may be responsible for gathering or determining event data 550 including endpoint data and/or network data. A number of different program modules and data files may be stored in the system memory 520. While executing on the processing unit 510, the program modules 540 may perform the various processes described above.

The computing device 500 may also have additional features or functionality. For example, the computing device 500 may include additional data storage devices (e.g., removable and/or non-removable storage devices) such as, for example, magnetic disks, optical disks, or tape. These additional storage devices are labeled as a removable storage 560 and a non-removable storage 570.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 5 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device on the single integrated circuit (chip). The disclosure may also be practiced using other technologies capable of performing logical operations such as, for example, AND, OR, and NOT, including but not limited to mechanical, optical, fluidic, and quantum technologies.

The computing device 500 may include one or more communication systems that enable the computing device 500 to communicate with other computing devices such as, for example, servers, routers, network devices, client computing devices, etc. Examples of communication systems 580 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 500 may also have one or more input devices and/or one or more output devices shown as input/output devices 590. These input/output devices may include a keyboard, a sound or voice input device, haptic devices, a touch, force and/or swipe input device, a display, speakers, etc. The aforementioned devices are examples and others may be used.

The term computer-readable media as used herein may include non-transitory computer storage media. Computer storage media may include volatile and nonvolatile, removable and non-removable media implemented in any method or technology for storage of information, such as computer readable instructions, data structures, or program modules.

The system memory 520, the removable storage 560, and the non-removable storage 570 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media may be tangible and non-transitory and does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The terminology used herein is for the purpose of describing particular embodiments only and is not intended to be limiting of the inventive concept. Also, unless explicitly stated, the embodiments described herein are not mutually exclusive. Aspects of the embodiments described herein may be combined in some implementations.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure.” Also, the term “exemplary” is intended to refer to an example or illustration. As used herein, the terms “use,” “using,” and “used” may be considered synonymous with the terms “utilize,” “utilizing,” and “utilized,” respectively.

Although exemplary embodiments of systems and methods for protecting computing systems using declared constraints have been specifically described and illustrated herein, many modifications and variations will be apparent to those skilled in the art. Accordingly, it is to be understood systems and methods for protecting computing systems using declared constraints constructed according to principles of this disclosure may be embodied other than as specifically described herein. The disclosure is also defined in the following claims, and equivalents thereof.

What is claimed is:

1. A method comprising:
receiving a request to make a configuration change to a component of a telecommunications network;
applying a rule to the request and generating an output;
rejecting the request in response to the output indicating a first result; and
processing the request in response to the output indicating a second result.

2. The method of claim 1 further comprising:
storing the request in a staging directory; and
moving the request from the staging directory to a running directory in response to the output indicating the second result.

3. The method of claim 1, wherein the request is a request to change a configuration parameter of a device coupled to the telecommunications network.

4. The method of claim 1, wherein applying the rule includes:
determining whether the request meets as set of syntactical requirements; and
when the request meets the set of syntactical requirements, determining whether the configuration change, in combination with other change requests, exceeds a limit for the telecommunications network.

5. The method of claim 4, wherein the limit comprises a limit on a rate of change for a number of change requests in the telecommunications network.

6. The method of claim 5, wherein the limit on the rate of change is a limit on a rate of change for a number of change requests of a particular type in the telecommunications network.

7. The method of claim 4, wherein the request comprises a configuration change object and applying the rule comprises determining whether the configuration change object is dependent on any other object.

8. The method of claim 1, wherein the request comprises a configuration change object and applying the rule comprises determining whether a reference within the configuration change object to a security certificate is correct.

9. The method of claim 1, further comprising, prior to receiving the request:
receiving the rule;
storing the rule in a staging directory;
determining whether the rule is valid; and
when the rule is determined to be valid, moving the rule to a running directory.

10. The method of claim 1, wherein determining applying the rule to the request comprises:
generating the first output when the configuration change exceeds a limit for the telecommunications network;
automatically sending a notification to an operator;
receiving instructions to change the limit to a new limit; and
generating the second output when the configuration change does not exceed the new limit for the telecommunications network.

11. A system comprising:
at least one processor;
memory, operatively connected to the at least one processor and storing instructions that, when executed by the at least one processor, cause the system to perform a method, the method comprising:
receiving a request to make a configuration change to a component of a telecommunications network;
applying a rule to the request and generating an output;
rejecting the request in response to the output indicating a first result; and
processing the request in response to the output indicating a second result.

12. The system of claim 11, wherein the method further comprises:
storing the request in a staging directory; and
moving the request from the staging directory to a running directory in response to the output indicating the second result.

13. The system of claim 11, wherein the request is a request to change a configuration parameter of a device coupled to the telecommunications network.

14. The system of claim 11, wherein applying the rule includes:
determining whether the request meets as set of syntactical requirements; and
when the request meets the set of syntactical requirements, determining whether the configuration change, in combination with other change requests, exceeds a limit for the telecommunications network.

15. The system of claim 14, wherein the limit comprises a limit on a rate of change for a number of change requests in the telecommunications network.

16. The system of claim 15, wherein the limit on the rate of change is a limit on a rate of change for a number of change requests of a particular type in the telecommunications network.

17. The system of claim 14, wherein the request comprises a configuration change object and applying the rule comprises determining whether the configuration change object is dependent on any other object.

18. The system of claim 11, wherein the method further comprises, prior to receiving the request:
receiving the rule;
storing the rule in a staging directory;
determining whether the rule is valid; and
when the rule is determined to be valid, moving the rule to a running directory.

19. The system of claim 11, wherein determining applying the rule to the request comprises:
generating the first output when the configuration change exceeds a limit for the telecommunications network;
automatically sending a notification to an operator;
receiving instructions to change the limit to a new limit; and
generating the second output when the configuration change does not exceed the new limit for the telecommunications network.

20. A method comprising:
receiving a rule;
storing the rule in a staging directory;
determining whether the rule is valid;
when the rule is determined to be valid, moving the rule to a running directory;
receiving a request to make a configuration change to a component of a telecommunications network, the request comprising a configuration change object;
storing the request in the staging directory;
applying the rule to the request and generating an output;
when the rule is determined to be satisfied by the request, moving the configuration change object into the running directory.
